(19) United States
(12) Patent Application Publication
(10) Pub. No.: US 2010/0267376 A1
(43) Pub. Date: Oct. 21, 2010

(54) Accessory Configuration and Management

(75) Inventors: Jarmo Ilkka Saari, Turku (FI); Jani Mikael Pirkola, Oulu (FI); Kari Matias Severinkangas, Oulu (FI); Dan Ion Dumitrescu, Espoo (FI); Christoph Erdmann, Bergisch Gladbach (DE); Raul Lozano, Espoo (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/809,019

(22) PCT Filed: Dec. 17, 2007
(86) PCT No.: PCT/IB07/03953

§ 371 Date: Jun. 17, 2010

(51) Int. Cl. H04M 3/00

(52) U.S. Cl. 455/418

(57) ABSTRACT

The invention provides methods and devices for configuring or displaying parameters of an accessory device at a connected device. A template file including parameters and associated user interface components is stored at the accessory and transmitted when required, and the receiving device may, based on this template file and current parameter values received in a separate message, create a user interface for display and/or configuration of parameters.

### TECHNICAL FIELD

The invention is related to accessory devices, and more particularly, to the configuration of parameters of an accessory device at a main device.

### RELATED ART

Many electronic devices allow for attachment of additional accessory devices. Such accessories may add certain functionalities to a device. Accessories devices are particularly useful for portable devices which, due to their limited dimensions, do not include all features a user may wish for. Furthermore, external or accessory devices facilitate adaptation of a device, whether portable or not, to specific applications and, requirements. As an example, a headset may be connected to a personal computer or a handheld computer as well as a mobile phone. In all cases, the headset (or any other accessory) may use a wired connection and a suitable data interface such as USB, firewire or the like, or a wireless connection such as Bluetooth, infrared, wireless local area network (WLAN), Ultra Wideband (UWB) or any other connection method.

Certain functionalities of accessories will then usually operate using preset default parameters, such as a device identifier, a PIN number, a transmission channel or a default volume setting. The specific parameters will be dependent on the type of accessory device, but will generally be stored in the device. Usually, a user does not have the possibility to change such parameters directly. In order to modify a preset parameter, it might be necessary to connect the device to a computer and sometimes even to use special software which allows for reading and modifying those parameters. In other cases, preset parameters cannot be changed at all. Even if parameter modification is possible, the procedure is mostly complicated and can only be performed with additional software tools or extensive technical knowledge.

### SUMMARY

The invention provides a configuration method for enhancement and/or accessory devices, as well as corresponding devices. According to an exemplary implementation, a method is provided comprising: retrieving a template file including at least parameters and associated user interface components; receiving a set of current parameter values; creating a user interface based on said template file and said current parameter values; determining modified parameter values obtained via said configuration user interface; and transmitting an update file including at least modified parameter values. The template file includes information which allows the creation of the user interface for displaying and/or configuring the parameter values. In other embodiments, no modified parameter values may be determined and transmitted, for example when read-only parameters are displayed in the user interface and no parameter values are configured.

In some embodiments, the method may further comprise transmitting a request for said template file. Such a request may for example be transmitted in response to a user input, which may be detected by a dedicated application or a function of another application.

Exemplary embodiments of a method include receiving at least one identifier indicating a current template version. Using this identifier, a method may optionally comprise determining a stored template file version, and comparing said stored template file version to said received current template version. In some embodiments, a result of said comparison of template versions may be transmitted subsequently.

The template file may in some embodiments be received via a communication, and in other embodiments the template file may be retrieved from a local memory element. Also, some embodiments may include both alternatives depending on triggering events.

In exemplary embodiments, the method may further comprise receiving a registration request for a configuration feature, and transmitting a registration confirmation.

The template file may include valid ranges for said parameters. Furthermore, the template file may include general information like help texts or/and a link to a Web page, read-only parameters, and other components.

According to some embodiments, the method may comprise checking whether said modified parameter values are within said valid ranges before transmitting said update file. If said check determines that said modified parameter values are outside said valid ranges, the method may further comprise requesting a user to enter valid parameter values. In other embodiments, the modified parameter values may be adapted to the valid ranges by a processing unit without any request to the user.

In some embodiments, said template file and/or said current parameter values are received in more than one message.

The template file may for example be provided in XML (Extended Markup Language) format, or alternatively in any other structured data format.

According to some embodiments, the above described method is performed in a mobile device. Also, said messages and files may be received from an accessory device connected to said mobile device.

According to a further aspect of the invention, a method is proposed which comprises in exemplary embodiments: transmitting a template file including at least parameters and associated user interface components; transmitting a set of current parameter values; receiving modified parameter values; effecting a device configuration using said received modified parameter values. The method may further comprise receiving a request for said template file.

In some embodiments, the method may comprise transmitting at least an identifier indicating a current template file version. Also, an exemplary embodiment may comprise receiving an indication that a current template file is not available at a remote device. In response to said indication, the method may include transmission of a current template file.

In some embodiments, the method may comprise transmitting a registration request for a configuration feature.

The template file may in exemplary embodiments further include valid ranges associated with said parameters. The template file and/or said current parameter values may optionally be transmitted in more than one message. According to an exemplary embodiment, said template file is in XML format.

According to exemplary embodiments of the invention, the further method as described above is being performed by an accessory device connected to a mobile device.

According to another aspect, a computer program product is provided comprising program code components which may, when executed, perform any of the above method steps.

According to another aspect of the invention, a device is provided which may comprise a connection interface for connecting to an accessory device; a communication unit configured for exchanging data with said accessory device; a processing unit configured for retrieving a template file including at least parameters and associated user interface components; receiving a set of current parameter values; creating a configuration user interface adapted for user input based on said template file and said current parameter values; a display adapted for displaying said user interface; and user input elements adapted for modifying parameter values indicated via said user interface.

### BRIEF DESCRIPTION OF FIGURES

In the following, the inventive concept will be described in more detail with reference to exemplary embodiments and in connection with the appended figures, where

FIG. 1 is an illustration of an exemplary system,

FIG. 2 shows an exemplary message flow between a main device and an accessory device in accordance with an exemplary embodiment of the invention,

FIG. 3 is a method flow diagram for an exemplary main device, and

FIG. 4 is a method flow diagram for an exemplary accessory device.

### DETAILED DESCRIPTION OF EXEMPLARY EMBODIMENTS

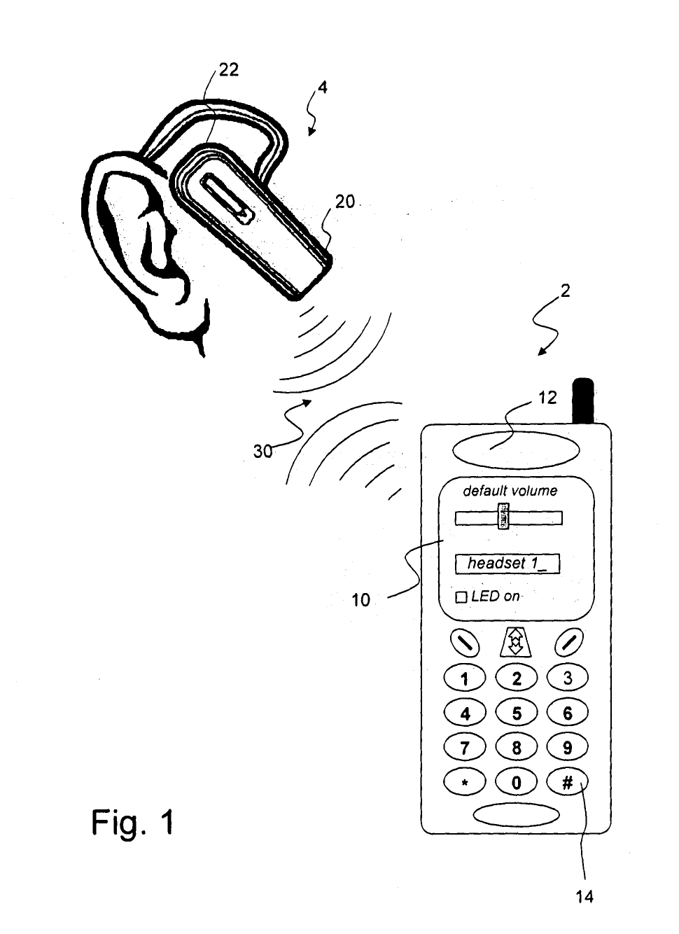

FIG. 1 depicts an exemplary inventive system. A main device 2 is provided, which may be any kind of electronic device. As an example, a main device 2 may be a portable device, such as a mobile phone, a mobile terminal, a mobile computer or a personal digital assistant. Other types of devices are conceivable and will be readily available to the person skilled in the art. For interaction with a user and generally for operation of the device, several interfacing elements 10, 12, 14 may be provided on the main device. These may include displays 10, keyboards, keypads 14, single keys, soft keys, scroll wheels, touch-sensitive surfaces and/or screens, microphones, speakers 12, signaling LEDs or any other part that allows a user to interact with the operation of the device. The device may further be provided with a processing element such as a CPU, and with volatile and/or non-volatile memory elements, (not shown). On the memory elements, executable applications may be stored as well as other operating data, and data input by a user or received via a data transmission may also be stored. As generally known for such devices, power supply may be provided by rechargeable or non-rechargeable battery, and/or by electrical connectors that allow connection to mains power or another energy source. A device may further include communication interfaces, for example for cellular communication services and/or non-cellular communication services.

Furthermore, one or more connection interfaces 30 may be provided for connecting the main device to various counterparts. A connection may for example be desired to a further, similar device, i.e. between two laptops or two mobile phones or two mobile devices for data transmission between those devices. Another option is a connection to an accessory device 4 which may provide certain extended features. The physical interface may be a wired or non-wired connection 30, such as a radio connection or an infrared connection. A variety of standards and implementations is available, and of course, the invention is not limited to those but may be uses with any data transmission method. Some examples, which shall not be seen as exhaustive, are USB, FireWire, Bluetooth, Ultra Low Power Bluetooth, IrDA, Ultra Wideband (UWB) and WLAN. The type of connection may also have an influence on the protocol used for data transmission between main device and accessory device. Often these terms are used to designate both the hardware interface and the transmission protocol.

One or more accessory devices 4 may be connected to the main device 2 via any of the exemplary connection interfaces as described above or any other connection. The accessory device may be any device that can be connected to the main device for cooperation. Examples are a headset, a GPS receiver, a webcam, a speaker set, a charger or a printer. In FIG. 1, a headset 4 is connected by way of example to the mobile device 2 via a Bluetooth connection 30. Each of these and many other accessories 4, sometimes also referred to as enhancements or peripherals, may be used in connection with a main device 2. The exemplary headset is provided with at least a microphone 20 and a speaker 22, and also with a radio transceiver unit (not shown) for connecting the headset to another device via a radio communication link 30. The functionality and elements of an accessory may vary widely, even between devices of the same type. Some accessory devices may include their own processors and/or controllers, storage means, internal bus systems and many more, while others have a simple setup with very limited functionality, mostly controlled by a connected main device. Usually, at least some memory element is provided for storing information of the accessory device. Stored information may include connection parameters such as a device ID, driver software, communication protocols, but also operating parameters such as a default frequency, access passwords, default volume, microphone sensitivity or data transmission rates. While accessories may be provided with user input elements such as buttons or scroll wheels, e.g. for adjusting the volume of a headset, they are usually not provided with extensive user interfaces such as displays and keypads. As mentioned before, a parameter configuration for a prior art accessory would thus require connecting the accessory to a computer and using special software for changing some registers in the accessory device.

Some embodiments of the invention allow to configure an accessory device using a configuration template that is provided by the accessory itself. In this way, a main device does not need any configuration tools for accessories, and parameters can easily be adapted also for unknown accessories. The concept of a configuration template will be described in more detail with reference to various examples below.

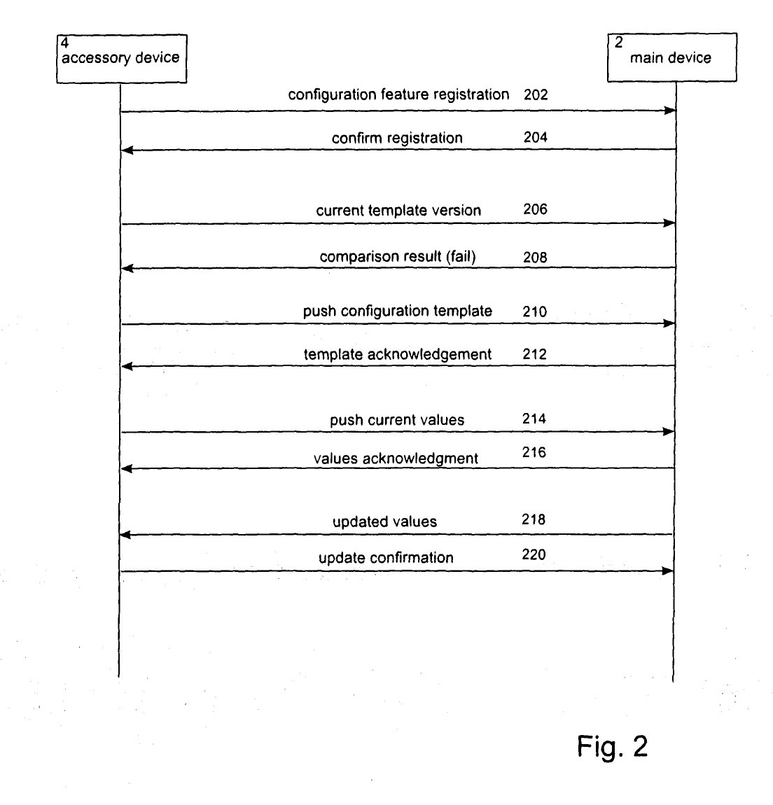

FIG. 2 illustrates an exemplary message flow between a main device and an accessory device in accordance with an exemplary embodiment of the invention. While each single arrow shall stand for information transmitted between those devices, such information may optionally be transmitted in more than one message or data unit or several messages may optionally be transmitted in a combined fashion. The number of messages used for transmission may depend on the desired or allowable message size, on structural considerations, or on physical conditions present on the connection. Not all of the messages or transmissions shown in FIG. 2 are required for implementing an embodiment of the invention and shall be regarded as exemplary features only, while additional messages or transmission sequences may also be transferred between these devices, or the described order may be different or described messages may be replaced by others. The example is given with reference to a single connection between a main device and an accessory device, but further connections to other devices may be present, using the same or a different physical and logical connection interface.

As a first communication between the connected devices, an initiation procedure may be performed. During such a procedure, authentication messages may be exchanged or certain connection parameters may be transferred. Also, compatibility or support for certain functions may be checked on one or both sides. Initiation and similar procedures may include only a single message or a message sequence with various responses and requests. Several protocol levels may exist between devices, such that several procedures of initiation may have to be completed. As an example, a first procedure may provide the physical connection details, such as transmission rate, device ID and so on, while a second procedure may be used for implementing a certain communication protocol and may be established in a similar or a completely different way. Implementations of those procedures are well known to the person skilled in the art and will not be described here any further. Again, the invention shall not be limited by any particular protocol, standard or communication sequence.

After an accessory device has been correctly initiated and/or authenticated at the main device, i.e. exchange of data and information is possible in accordance with a desired protocol, an exemplary embodiment of the inventive method may be implemented as described in the following.

In a first step, the accessory may register for the configuration feature with the main device. A registration message 202 may be transmitted to the main device by the accessory. This message indicates that the accessory supports a configuration feature and checks the main device's support of this feature. Additionally, certain parameters may be communicated in this message, such as a maximum message size to be used during configuration procedures.

In response to the registration message 202, the accessory may receive a registration confirmation message 204 which indicates that the configuration feature can be used. In case of any error at the main device, an error message may be transmitted to the accessory instead of the confirmation message. The error message may optionally indicate the type of error occurred, such that the accessory may determine whether another registration request should be send or not A registration may generally be performed after connection of the accessory to the main device, but in other embodiments registration at a later time, optionally triggered by some event, is also conceivable.

After registration has been, performed, the configuration feature is ready for use in the described example. A configuration procedure may then be initiated either by the accessory or the main device, and a system may implement one of these options or both in parallel. As a first case, initiation of the configuration sequence by the accessory will be discussed. A possibility for configuration may for example be required immediately after connection to the main device, or later during a session when certain parameters have changed at the accessory. In the example of FIG. 2, a first message 206 that is sent from the accessory device to the main device indicates the current template version that is stored at the accessory. As mentioned above, a template file is stored in a memory at the accessory and can be used by any connected main device which supports the configuration functionality. The template file may be identified by a template ID, a template name string, or also by several parameters such as a device ID, a template version date and a template language. This information is transmitted in the comparison request. In response, the main device sends a message 208 back to the accessory indicating a result of the comparison. The result may be provided in various ways; for example, the result may simply show the version number (or template ID and so on) of a template currently stored at the main device, with a predefined number or ID indicating that no template is stored at all. In other example cases, the result message may simply give a binary result, i.e. indicating a fail or success of the template file comparison. It shall be assumed for this example that the comparison has failed, so that the response message 208 may include a failure indication or a template version ID different from that stored at the peripheral device. In other cases, fail or success may be indicated by different messages, such as a template request message in case of a failed version comparison and a value request message in case of a successful comparison.

As a next step in this example, the template file is transmitted (step 210) from the accessory device to the main device. The main device may respond with an acknowledgment or confirmation message 212. In the template file, information is provided to the main device which allows the creation of a suitable user interface for parameter modification. The template file may include the type of accessory parameters which may be changed, help information for each parameter, type of user interface element, allowable parameter ranges and many more. The content and function of the template file will be described in more detail below. Then, the actual current values of the indicated parameters are transmitted in a further message. The confirmation message 212 transmitted in response to the template push message 210 may serve as a request for the current values, since it indicates that the main device is now ready to receive the next message. Subsequently, the current values may be pushed to the main device in a message 214. A confirmation 216 for the received current values may also be sent to the accessory. In all cases, the main device may also send an error message if the template file or the values have not been received correctly, which may trigger a retransmission of those messages. Finally, after parameter values have been updated at the main device, they are transmitted back to the accessory in a message 218, which may once more be confirmed by the accessory via a confirmation response 220.

It will be understood that in case of a comparison success response in message 208 of FIG. 2, the template file does not need to be transmitted to the main device. Thus, the template transmission and the associated response (messages 210 and 212) would be skipped, and the accessory would immediately send the current values to the main device.

A second case is user initiated accessory configuration. The main device may provide an application for configuring accessories which may be executed by the user, which will be described in more detail below. Such an application may trigger transmission of a configuration request message to the desired accessory, which is not shown in FIG. 2. In response to a configuration request, either a template comparison as illustrated by messages 206 and 208 may be initiated by the peripheral device, or the sending of configuration data (template file and/or current values) as in messages 210 and 214 may start without any preceding comparison step. Some exemplary embodiments may comprise configuration request messages which also include an indication of a template version currently stored at the main device, such that the additional comparison messages would not be necessary. In this case, the accessory would need to have some capability of comparing the received version indication to the current template file, while in the cases above the comparison is performed at the main device. Embodiments are conceivable where only one or both of the devices are able to compare template versions. Again, the configuration procedure would then either continue with the template push of message 210 if the template versions do not match or directly with the current value push of message 214 if the correct template version is already indicated in the request.

In some embodiments, a comparison of stored template versions (messages 206 and 208) may not be performed. This may for example depend on the processing of the template on the end of the main device. If the main device is able to store templates, a comparison may be provided. On the other hand, if the main device never stores or buffers templates, or if the comparison should not be implemented for another reason, the template file may be transmitted immediately on start of a configuration procedure. This is independent of whether the configuration procedure is triggered by the main device or initiated automatically by the accessory.

All files or information as described above may be transmitted in one or more separate data units or messages. Transmission in more than one message may e.g. be preferred when the size of the file to be transmitted, such as the template file, exceeds the allowable message size. Also, data may be split onto several messages for structural reasons, such as a substructure within a template file. Suitable identifiers may then be used to identify all associated messages for recombining the data. If one message from a set of associated messages has not been received correctly, retransmission of this message or all messages may be requested by another message (not shown in the example).

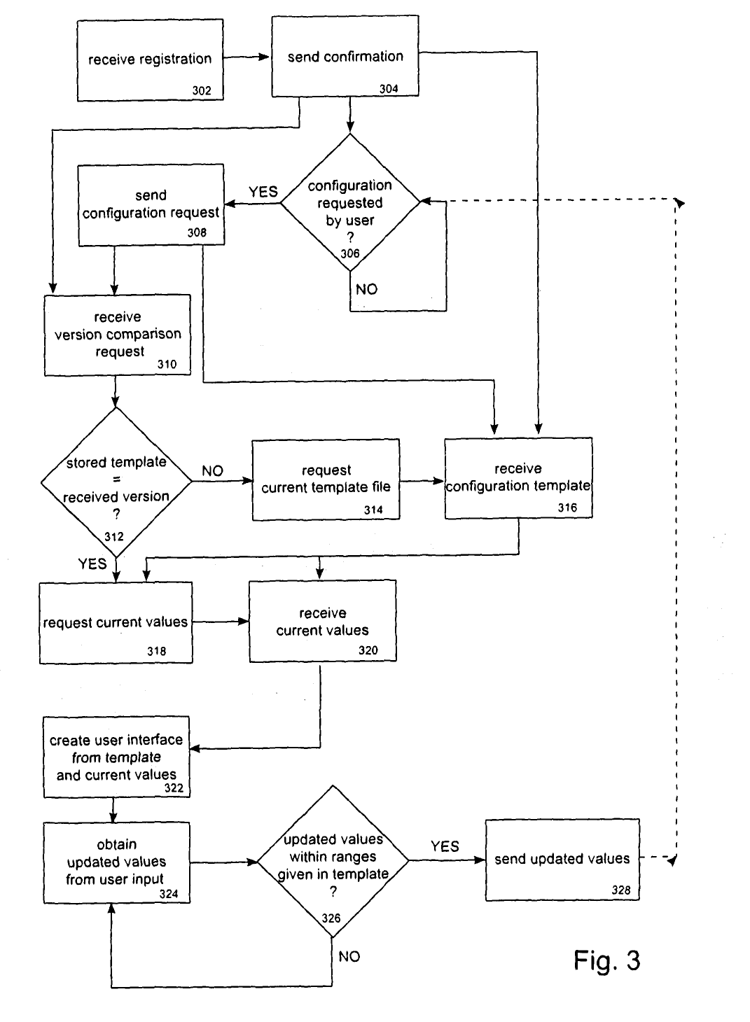

FIG. 3 shows a flow diagram for an exemplary method performed by an exemplary main device. As stated before, a main device may for example be a mobile phone or a mobile terminal or a portable computer, but also any other kind of electronic device connectable to accessories. In step 302, the registration message as described above (message 202 in FIG. 2) is received from an accessory device. If the device supports the configuration functionality, a confirmation message is returned in step 304. Otherwise an error message may be sent to the accessory. After a successful and confirmed registration, accessory configuration may be used at any time.

Again, there are several possibilities for initiating a configuration procedure, and these may be implemented all within one embodiment or only one of the possibilities. The main device may monitor incoming messages from the accessory which may start a configuration. These messages may be a request for comparing stored template files as in step 310, or a message directly including a template file (step 316) without any preceding comparison. With reference to FIG. 2 it has been described that a comparison of template files may be requested by the accessory device. When the main device receives such a request, it may check the version ID, version date, template name, or any other parameter(s) included in the comparison request, and compare these received parameters to the parameters of a stored template file in step 312. A successful comparison means that the required template file is already available at the main device and does not have to be transmitted again. If the comparison shows that the stored template is not the one used by the accessory, the correct template file is requested in step 314. Otherwise the response may indicate in step 318 to the accessory that only the current values need to be transmitted.

If no template file is stored, for example if template file storage is not supported by main the device, a predefined value may be returned in a response message, or the current template file may be requested. It shall be noted that in the example of FIG. 3, it is shown that the result of the comparison in step 312 leads to one of two different requests 314 or 318 being issued. While this is one possible embodiment, in other embodiments the request may be the same in both cases, but may include different values for indicating the result of the comparison to the accessory. The response message (corresponding to message 208 in FIG. 2) may for example indicate the version parameters of the stored template file or a binary flag.

In other cases, the configuration procedure may be requested by the device user or by an application on the main device. In order to allow, the user to start accessory configuration, an application may be provided on the main device. The application may be a process of another application, or a small standalone tool. Such an application may also allow a user to choose one of several connected accessory devices. In response to a user input at the main device requesting configuration in step 306, the main device may send a configuration request message to the accessory in step 308.

The template file that is used in this embodiment is a file that includes various parameters and information on the configuration function. The actual parameter values are not included in this file, but are transmitted in a separate message. Basically, the template file is provided to the main device in order to define a user interface and all necessary boundary conditions for user parameter modification. Several different templates may be provided at the accessory, e.g. templates in various languages. The required language may for example be queried in the registration step or in a template request. A template file version may be indicated by one attribute of the file that includes information on the accessory model, the software version and the language. These may also be queried in a comparison request as described for steps 310 and 312.

In further embodiments, a template language may be selected based on the current operating language of a main device. If for example a mobile device is configured to use English as language for all applications, this may be indicated automatically in a registration response message, a version comparison or a template request. In other cases, an accessory device may specifically query the language used by the operating system in any of the described messages or in an extra message. Such a language query message may for example be sent after a registration message, before sending a template. In response to the language indicated in a response from the main device (or in any other message without a previous request), the accessory is then able to select the corresponding language for a template file and transmit this template file. Several template files in different languages may be stored at the accessory for this purpose. Other than the text elements and menus displayed to the users, the template files are the same. It will be understood that a language query may also be skipped if it is not supported by one of the devices. For example, if the accessory can derive from a registration response that the main device does not support several languages, the query message may be skipped. In other example cases, when the accessory does not have several file versions in different languages stored, it is evident that the set language of the main device does not need to be queried.

For purposes of creating the user interface, the template file may further comprise user interface components which may be displayed at the main device in graphical form. Examples of such components are sliders, text editors, check boxes, selection lists and others. Each interface component is associated with a parameter of the accessory that is open for configuration. Some examples of configurable parameters with reference to the headset example are a connection name (e.g. a Bluetooth name), a PIN number, LED function, default volume. It will be understood that the interface components are chosen with respect to the parameter, and that the types of interface components present in a template file will depend on the types of accessory parameters and the desired configuration functionalities.

Additionally information like a help text and/or a link to a Web page may be associated with each parameter and thus with each of the interface components. This information may then be displayed to a user automatically or on request, or only in response to certain events. The content of the information may for example comprise information on the allowed settings or on the impact of a changed setting. Further, range specifications may be given for parameters where necessary, such as for freely editable parameter fields or for sliders. The ranges may then be used in various ways; for example, the effect may be that the user interface is automatically created with certain threshold values, e.g. for a slider that has a maximum position. In other embodiments, a comparison of input values with these ranges may be performed (step 326 in FIG. 3) before the updated values are returned to the accessory. The associated elements within the template file, i.e. a certain parameter together with its user interface component and information, may form a subset. Data may be structured within the file in a way that allows defining a set of parameters and for each parameter the associated elements as described above. Within the file, each parameter may be identified by a parameter ID for the accessory or another identifier, and a separate parameter name may be provided within the substructure for displaying the parameter to the user or for communication with the main device.

Besides the configurable parameters and their associated information, read-only information may also be included in the template file, optionally with suitable user interface elements as well. This may allow showing a battery level or another non-configurable parameter to the user, for bask information or for supporting configuration decisions. A main device may in some embodiments also request only to read certain information without any configuration, and it will be understood that no modified data will be sent back to the accessory in this case. Still, the user interface components for read-only data are also included in the template file, such that the interface can be created at the main device using e.g. a text box for displaying a string or number, or a volume bar without possibilities for modification. Read-only and configuration parameters may be displayed at the same time or separately.

All data for the template file may be included in an XML (extended markup language) format or another format that allows for structured inclusion of data together with user interface components. The general principle of XML files, their features and advantages are known in the art and will not be described in detail here. An example template file shall be given in the following.

```
<?xml version=“1.0” encoding=“UTF-8” ?>
  −<bt_hs_config_app xmlns:xsi=
  “http://www.w3.org/2001/XMLSchema-instance”
  xsi:noNamespaceSchemaLocation=
  “C:\example\bt_hs_config_app.xsd”>
  −<selection_list_item label=“Headset Status Information”>
    −<status_widget label=“Software Version” param_id=“10002”>
  <help_text>This control displays the software version running in the
  headset</help_text>
      </status_widget>
  −<status_widget label=“Hardware Version” param_id=“10003”>
    <help_text>This control displays the hardware version of the
  headset</help_text>
      </status_widget>
      </selection_list_item>
  −<selection_list_item label=“General Headset Settings”>
    <slider_widget max=“16” label=
    “Default Volume Level” param_id=“10005” min=“1” />
  <help_text>This control sets the default volume level</help_text>
      </selection_list_item>
  −<string_editor_widget label=
  “PIN Code Change” param_id=“ID_10006”>
    <help_text>This control allows modification of the headset PIN
  code</help_text>
      </string_editor_widget>
</bt_hs_config_app>
```

Again, a headset configuration is chosen by way of example. Here, four parameters are indicated in the template file for configuration and/or display, namely software version, hardware version, default volume level and PIN code change. Three of the parameters are structured into two groups, “general headset settings” and “headset status information”, while the last parameter is outside of these subgroups. Each of the parameters is associated with a user interface component, a label, a parameter identifier, and a help text. In the case of the volume level, a valid range is also indicated. It will be understood from the example template that this template shows all elements required for providing a user interface. The definitions for the various user interface components which may be used in a template may be given in a XML schema definition (XSD) file or any other definition file which provides a similar function of defining syntax and structural features of the actual template.

Looking at the example in more detail, the template provides a selection list for the two types of data, indicated by “selection_list_item”. A user interface may then present the associated item labels, “general headset settings” and “headset status information” to a user in form of a list for selection. As a substructure of these two items, further items may be provided. When a user chooses “headset status information”, there are two parameters falling under this subgroup. A first parameter is labeled “software version”. This parameter has an associated numerical parameter identifier param_id, which allows both the accessory and the main device to relate to the correct parameter in the current parameter file or the updated parameter file. The parameter is associated with a “status_widget” as a user interface component, which may be any kind of read-only display that allows to show the status of a certain parameter associated with this widget or component. Further, a help text is provided which may be displayed in the user interface as well. The second parameter in the group, “hardware version”, is implemented in the same way as a read-only parameter. It can be seen that after these two elements, the first “selection_list_item” is terminated.

The second selection list item “general headset settings” has only one parameter in the present example. Instead of a read-only user interface component, a “slider_widget” is indicated for the parameter “default volume level”. Besides the numerical parameter identifier and a help text, this parameter also includes a maximum and minimum value for the associated parameter, which may be both displayed to a user and used for checking modified values for range validity. A slider may for example be a graphical slider element that may be displaced or adjusted by a user via a touch screen or keys. The user interface components are only mentioned here by way of example, and other components may be used as well.

The last parameter in the example template is the PIN code. This parameter is associated with a “string_editor”, which may be an editable text box component in a user interface that allows a user to enter a new string via a keyboard or key pad for changing the PIN code of the headset. While no range values are shown here, it is also conceivable to include further max/min values to e.g. only accept four-digit pin codes, or any other restriction on the input. It will be understood that, as described before, several of these template files may be stored at a device, with each only differing in the language used for the help text and parameter labels.

The language may e.g. be indicated by a specific file name that allows the accessory to choose the template which has the desired language. It is further conceivable to provide an XML file which has a first selection list for different languages, and then provides under each selection list item the complete actual user interface template in different languages. In this way, also devices which do not allow a language query or do not support different languages may benefit from localized user interfaces. When the user interface is generated at the main device, a user may then be able to choose his language, and then proceed as described for the configuration template.

The further method steps performed at an exemplary main device shall again be described with reference to FIG. 3. After a correct template file has been received in step 316 or verified in the comparison of step 312, a second message including the current values of the parameters defined in the template file is received in step 320. The reception of the current value message may be preceded by a separate request for the current values in step 318, in particular when no template file is transmitted. Also, an optional confirmation or acknowledgment message sent to the accessory in response to a received template file may serve as a request for the current values as in step 320. The current value message may again be implemented in various ways, for example as a simple text or ASCII based message which only includes the parameter values with its associated parameter identifiers, such as

### 10002=1.00, 10003=0.6, 10005=3, ID_{—}10006=0000

for the example file above. The parameters identifiers have also been used in the template file in order to define user interface components and user information for a specific parameter. In other embodiments, the current parameters may be included in a structured file, such as an XML file, or a file including a spreadsheet with predefined parameter fields. Other concepts for transmitting parameter values with their corresponding identifiers may be used alike.

Using the received or stored template file and the received current parameter values, the main device is now able to create a user interface for configuring the accessory in step 322. The template file may include, as described above, the parameters that can be modified, allowable ranges for these parameters, parameter names, information for the user like help texts, and user interface elements such as checkboxes or lists. Furthermore, the template file may include read-only information, such as a battery status or software version, that may be displayed to a user with the same user interface provided for configuration. The template file may be provided in a suitable standard language which allows the main device to create a user interface with very little prerequisites for the main device, such as a XML file that provides all necessary information. Correspondingly, the user interface is displayed to the user on the main device. Referring to the headset example, a slide or scroll bar may be provided for default volume setting, a text field for entering a new device name, a selection of different radio transmission frequencies, and checkboxes for activating encryption. Of course, other or more parameters may be modified using such a procedure and the parameters and interface elements given are chosen by way of example only. Control of the user interface may be achieved by any available user input means, such as scroll wheels, keypads or touch screens. It is also conceivable to provide different template files or different options within a template file for different devices, such that a user interface may be adapted more conveniently to the respective available input means.

It is not necessary that the creation of the user interface and subsequent user input occurs directly after the template is received at the main device. In some embodiments, the template file may be stored or at least buffered until it is needed, and then the further configuration steps may be executed when configuration is desired. Further there might be embodiments where the information of the template file and the current value information are combined in one configuration file or message which would also impact the communication protocol between the main device and accessory device.

The main device detects the user input from the user interface in step 324. Although parameter ranges may be shown to the user or mentioned in the help information, the main device may in some embodiments check whether the modified parameters are within the ranges indicated in the template file for each parameter in step 326. If a parameter has been input by a user that is outside an allowed parameter range, the device may issue an error message to the user or correct the parameter automatically. As an example, when a parameter above a threshold defined in the template file is set by the user, the parameter may be set automatically to the highest allowed value. When all modified parameters are within the predefined parameter ranges, they are combined into a parameter update message (message 218 in FIG. 2) and transmitted to the accessory in step 328. It shall be noted that usually only the modified parameter values are transmitted back to the accessory; however, it is also conceivable to transmit all parameters in some embodiments if message size is not important and to facilitate handling at the accessory and even there might be embodiments where a configuration file is sent back including the template information. After the updated values have been transmitted to the accessory and the configuration has thus been completed, the device is ready for another configuration procedure. Optionally, successful completion of the configuration may also be indicated to the main device by another message from the accessory.

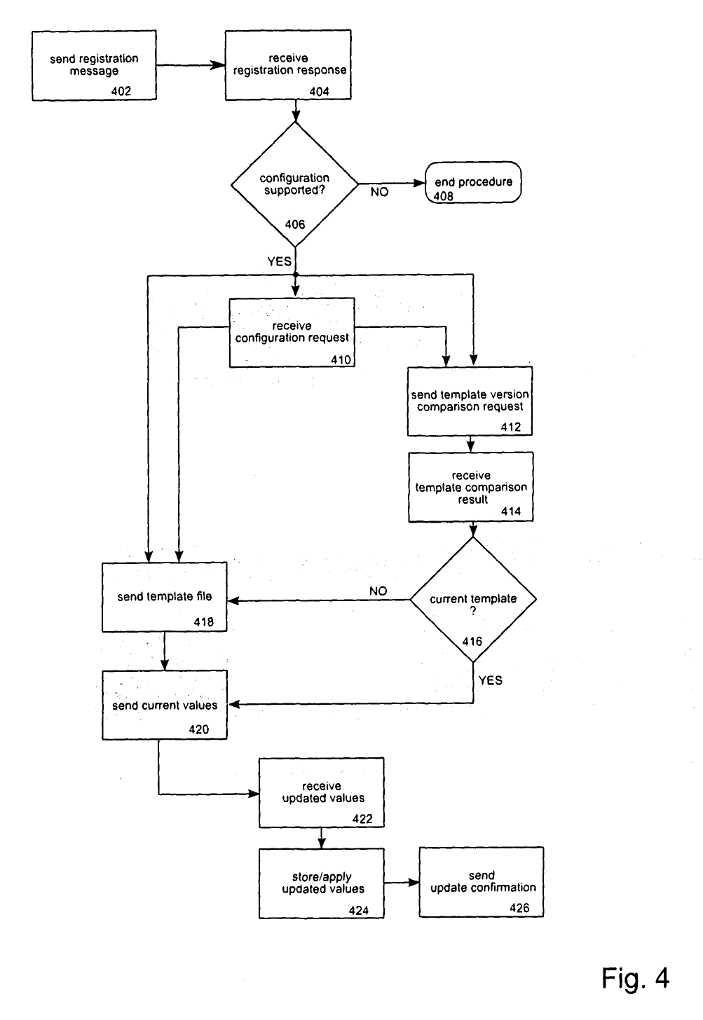

FIG. 4 is a flow diagram for an exemplary method performed within an accessory device. A Bluetooth headset is again chosen by way of example, but the general concept may be transferred to any arbitrary accessory device. After connection of the accessory to a main device such as a mobile phone, a registration message for the configuration feature is sent which indicates the support of the accessory for this feature in step 402. A response from the main device may be received in step 404 and evaluated in step 406. If the configuration feature is not supported by the main device, the procedure may stop at this point. Of course, in some embodiments the response may also include specific error messages which may indicate that support will be provided, but registration can currently not be performed, which may trigger the enhancement to resend the registration message of step 402 at a later time. If no response is received at all, the accessory may send the registration request again or assume that the feature is not supported. In the case of a main device which supports the configuration of the invention, there are several options indicated by different transitions in FIG. 4. As described before, the main device may initiate a configuration procedure, and in this case a configuration request may be received by the accessory in step 410. In other embodiments or also in the same embodiment, a configuration may be initiated automatically by the accessory itself. For this purpose, the accessory may transmit a template version comparison request to the main device in step 412, requesting to check whether the required template is already available locally. The message may include a template version number, a template language, a device ID, a template date and/or any other suitable indicators for a version check. The accessory may then receive a comparison result in step 414, which may indicate the respective template version identifier of a template stored at the main device. In other embodiments, the result may include a binary flag indicating a fail or success of the comparison, i.e. a “success” in case the template versions of accessory and stored template at main device match, and a “fail” in all other cases. The result may be evaluated in step 416. This would be the easiest implementation for the accessory. If a version number or date is indicated, the accessory requires some additional capability for comparing this version number with the current template. Another alternative is the embodiment of FIG. 3 that has been described above, where the comparison result is not indicated by a flag or variable within the otherwise same response message, but rather by directly requesting either a template file or the current values, i.e. different request messages which may for example use different headers. It shall be understood from the figure and from the above explanations that the configuration request from a main device received in step 410 may be followed by either one of steps 412 and 418, i.e. a transmission of a comparison request or a direct template file push.

A configuration may alternatively be initiated by the accessory by transmitting the template file in step 418 without any previous comparison check. After the template has been transmitted, the current parameter values are sent in another message in step 420. It will be understood that the current values may also be pulled by the main device, similar to the configuration request in step 410, such that the accessory would receive another request for current values and perform step 420 only after this request.

After the current template file and the current parameter values have been made available to the main device, the accessory may receive updated values at any time in step 422. There may also be further communication or events before this step, since the configuration is not necessarily performed immediately at the main device. As soon as updated values have been received, these may be applied to the current configuration in step 424. Depending on the implementation, updated values may come into effect immediately or only after a restart of the device. For this purpose, updated configuration values may also be stored in a memory element at the accessory. The procedure may be completed by transmitting an update confirmation message 426 to the main device, or an error message in case of any problems. It shall be noted that in the flow charts only exemplary embodiments have been described, and that the method flow may be different in other embodiments.

Although exemplary embodiments of the present invention have been described, these should not be construed to limit the scope of the appended claims. Those skilled in the art will understand that various modifications may be made to the described embodiments and that numerous other configurations or combinations of any of the embodiments are capable of achieving this same result. Moreover, to those skilled in the various arts, the invention itself will suggest solutions to other tasks and adaptations for other applications. It is the applicant's intention to cover by claims all such uses of the invention and those changes and modifications which could be made to the embodiments of the invention herein chosen for the purpose of disclosure without departing from the spirit and scope of the invention.

1-41. (canceled)

42. A method comprising:
retrieving a language specific template file including at least parameters and associated user interface components;
receiving a set of current parameter values; and
creating a language specific user interface based on said language specific template file and said current parameter values.

43. The method according to claim 42, further comprising:
displaying at least one of said current parameter values via said created language specific user interface.

44. The method according to claim 42, further comprising:
determining modified parameter values obtained via said language specific user interface; and
transmitting an update file including at least modified parameter values.

45. The method according to claim 42, further comprising:
transmitting a request for said language specific template file.

46. The method according to claim 45, wherein said request is transmitted in response to a user input.

47. The method according to claim 42, further comprising:
transmitting a language preference parameter for said language specific template file.

48. The method according to claim 42, wherein said language specific template file further includes valid ranges for said parameters.

49. The method according to claim 48, further comprising:
checking whether said modified parameter values are within said valid ranges before transmitting said update file.

50. The method of claim 42, further comprising retrieving said language specific template file from an accessory device.

51. A method comprising:
transmitting a language specific template file including at least parameters and associated user interface components; and
transmitting a set of current parameter values.

52. The method according to claim 51, further comprising:
receiving modified parameter values; and
effecting a device configuration using said received modified parameter values.

53. The method according to claim 51, further comprising:
receiving a request for said language specific template file.

54. The method of any of claims 51, further comprising
transmitting at least an identifier indicating a current template file version.

55. The method according to claim 51, further comprising:
receiving an indication of a language preference, and selecting, for transmission, one of a number of language specific template files corresponding to the indicated language preference.

56. The method according to claim 51, wherein said language specific template file and/or said current parameter values are transmitted in more than one message.

57. The method according to claim 51 being performed by an accessory device connected to a mobile device.

58. An apparatus comprising:
a connection interface configured to connect to an accessory device;
a communication unit configured to exchange data with said accessory device;
a processing unit configured to retrieve a language specific template file including at least parameters and associated user interface components;
receive a set of current parameter values;
create a language specific user interface based on said language specific template file and said current parameter values; and
a display configured to display said language specific user interface.

59. The apparatus according to claim 17, further comprising:
user input elements configured to modify parameter values indicated via said language specific user interface.

60. An apparatus comprising:
a communication interface configured to connect to a further device;
a memory element configured to store at least a set of current parameter values and at least one language specific template file, said at least one language specific template file including at least parameters and associated user interface components;
a processing unit configured to
transmit said language specific template file and said set of current parameter values to said further device.

61. The apparatus according to claim 60, wherein said processing unit is further configured to
update current parameters in accordance with an update file received in response to said current parameter values.
